(19) United States
(12) Patent Application Publication
(10) Pub. No.: US 2003/0068143 A1
(43) Pub. Date: Apr. 10, 2003

(54) Method and apparatus providing fiber optic cables through gas service pipes

(76) Inventors: Eric Martinez, Lilburn, GA (US); George Comer, Tyrone, GA (US)

Correspondence Address: MCKENNA LONG & ALDRIDGE LLP, 1900 K STREET, NW, WASHINGTON, DC, 20006, US

(21) Appl. No.: 09/973,070

(22) Filed: Oct. 10, 2001

(51) Int. Cl. G02B 6/44; B65H 20/00

(52) U.S. Cl. 385/100; 226/1

(57) ABSTRACT

An apparatus for supplying network services over fiber optic cable to a particular building includes a gas service pipe. The service pipe conveys gas between a gas main and a gas meter for the particular building. A flexible tube is disposed inside the service pipe. The tube is sealed at each end to an outside surface of the service pipe at a pressure fitting for providing access to the inside of the tube. A fiber optic cable is disposed through the inside of the flexible tube, with each end of the fiber optic cable outside the service pipe. Using techniques of the present invention, service pipes are employed to connect network cable to buildings across a paved street. The techniques avoid the costs and inconvenience associated with standard practices that involve cutting trenches across the streets.

### BACKGROUND OF THE INVENTION

1. Field of the Invention

The present invention generally relates to laying fiber optic cable for providing network services. The invention relates more specifically to techniques providing fiber optic cables through gas service pipes.

2. Discussion of the Related Art

As increasing use is made of computer networks, including the Internet, to provide information, demands have increased for increasingly fast delivery of that information. Fiber optic cable provides more information per second (called bandwidth), requires less energy, and produces less heat than metal wire of the same thickness. Consequently there is an ever-increasing demand for fiber optic cable connections to homes and businesses.

Unlike metal wires and cables that already go to essentially all home and businesses in the form of telephone wires and power cables, fiber optic cables are available to only a small fraction of homes and businesses. Consequently there is an extensive effort underway to deliver fiber optic cable to more homes and businesses. Communication companies and computer network service providers are expending great effort, including investing great sums, to bring fiber optic cable to more homes and businesses. The effort is especially intense in cities where more potential customers are reached with every mile of cable laid than are reached per mile in rural areas.

Fiber optic cables are usually buried to protect from exposure to weather and accidents and to protect from vandalism. In addition, may community regulations require cables be buried. Burying fiber optic cables in cities is inconvenient and costly. Roads are closed for days at a time while trenches are cut, cable is laid, junction boxes are installed, cables are connected, and roads are repaired. There is a trend among some communities to require cable-laying contractors to repave the streets rather than just patch the cut. All these factors increase the cost per unit distance of laying the cable in cities.

It has been recognized that trenching and repair costs might be reduced if fiber optic cable is laid inside gas mains and sewers.

A proprietary system has been developed that pulls cable through long haul gas mains, which transport gas from one region of the country to another. The gas in the long haul mains is under high pressure, for example at about 1200 pounds per square inch gauge (psig). A gauge pressure is measured relative to atmospheric pressure. Another proprietary system has been developed for pulling fiber optic cable through pressurized gas mains within cities. Gas mains are so designated by the gas utilities that operate them, and provide gas for a large number of customers, usually spread over many city blocks. Gas mains typically run through public property or easements.

However, the proprietary systems are not designed for the gas service pipes, which branch from the street gas main to buildings of gas customers. Gas service refers to pipes and fittings that are used to convey gas from a gas main to an inlet side of gas metering equipment. As used herein, service pipes refer to pipes employed in such gas service. Service pipes include branch service pipes that convey gas to multiple gas meters and single service pipes that convey gas to a single meter. Service pipes typically run across private property. Service pipes are often under 12 inches in diameter and typically 6 inches or less in diameter. Service pipes are typically operated at about 60 psig, and are often tested at maximum pressures of about 100 psig. There are indications that the proprietary systems are too costly to apply on the short runs of service pipes, and would not even work on most of the smaller diameter service pipes.

It is a disadvantage to be unable to pull fiber optic cable through service pipes. Many buildings targeted for fiber optic connections are across paved streets from the fiber optic network cables that are already connected to the network, even when the street gas mains carry the network cable using a proprietary system. If the service pipes are not employed to connect network cable to such buildings, then standard practices are employed from a street main or from any other conduit carrying network cable located across a street. The standard practices involve cutting trenches across the streets once per block, with all the commensurate costs and inconvenience.

Based on the foregoing description, there is a clear need for techniques that provide fiber optic cable through gas service pipes.

### SUMMARY OF THE INVENTION

Accordingly, the present invention is directed to method and apparatus for providing fiber optic cables through service pipes that substantially obviates one or more of the problems due to limitations and disadvantages of the related art.

According to one aspect of the invention, an apparatus for supplying network services over fiber optic cable to a particular building includes a gas service pipe. The service pipe conveys gas between a gas main and a gas meter for the particular building. A flexible tube is disposed inside the service pipe. The tube is sealed at each end to an outside surface of the service pipe at a pressure fitting for providing access to the inside of the tube. A fiber optic cable is disposed through the inside of the flexible tube, with each end of the fiber optic cable outside the service pipe.

According to another aspect of the invention, a method for pulling fiber optic cables through service pipes includes stopping gas flow from a gas main to a gas service pipe. A first nipple is joined to the service pipe at a first location convenient for connecting fiber optic cable to the particular building. The first nipple provides a pass way between the inside and the outside of the service pipe for a flexible tube. A second nipple is joined to the service pipe at a second location convenient for connecting fiber optic cable to a network cable. The second nipple provides a second pass way between the inside and the outside of the service pipe for the flexible tube. The flexible tube is fed through a catch nipple, after passing the flexible tube through the other nipple and through the inside of the service pipe. The flexible tube is sealed to the first nipple and to the second nipple for pressures up to a predetermined maximum pressure. A fiber optic cable is fed through the flexible tube.

According to another aspect of the invention, a method for supplying network services over fiber optic cables to a particular building includes sealing a flexible tube in a service pipe from a first point proximate to the particular building to a second point proximate to a network cable. The service pipe conveys gas between a gas main and a gas meter for the particular building. The tube is sealed for pressures up to a predetermined maximum pressure. A fiber optic cable is fed through the flexible tube. A first end of the fiber optic cable adjacent to the first point is connected to equipment in the particular building. A second end of the fiber optic cable adjacent to the second point is connected to the network cable.

Using techniques of the present invention, service pipes are employed to connect network cable to buildings across a paved street. The techniques avoid the costs and inconvenience associated with standard practices that involve cutting trenches across the streets.

Additional features and advantages of the invention will be set forth in the description which follows, and in part will be apparent from the description, or may be learned by practice of the invention. The objectives and other advantages of the invention will be realized and attained by the structures and steps particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exploded block diagram of a nipple assembly that forms a pressure tight seal between the nipple and a plastic tube, according to one embodiment;

FIG. 2 is a cross section of a service pipe with a fiber optic cable in a sealed flexible tube, according to an embodiment;

FIG. 3A and FIG. 3B together form a flow chart of a method for pulling fiber optic cable through a service pipe, according to an embodiment; and

FIG. 4 is a flow chart of a method for supplying network services over a fiber optic cable to a particular building, according to an embodiment.

### DETAILED DESCRIPTION OF THE PREFERRED EMBODIMENT

Reference will now be made in detail to the preferred embodiments of the present invention, examples of which are illustrated in the accompanying drawings.

Apparatus with Cable in Service Pipe

Embodiments of the invention make use of a nipple attached to a service pipe, that passes a flexible tube between the outside and the inside of the service pipe. The nipple has sidewalls that extend away from the outer surface of the pipe to which the nipple is attached. The sidewalls provide a means for attaching and removing other components. For example, the sidewalls include threads so that pressure fittings may be attached to the nipples to form pressure-tight seals up to a predetermined maximum pressure.

Any manner known in the art for forming nipples on pipes may be used. For example, a length of small-diameter pipe can be welded open end to an outer surface of a pipe. A hole of diameter substantially equal to the inner diameter of the small pipe is drilled into the portion of pipe covered by the small pipe. For another example, a section of metal pipe may be originally cast so as to form the nipple or a section of plastic pipe may be originally molded so as to form the nipple.

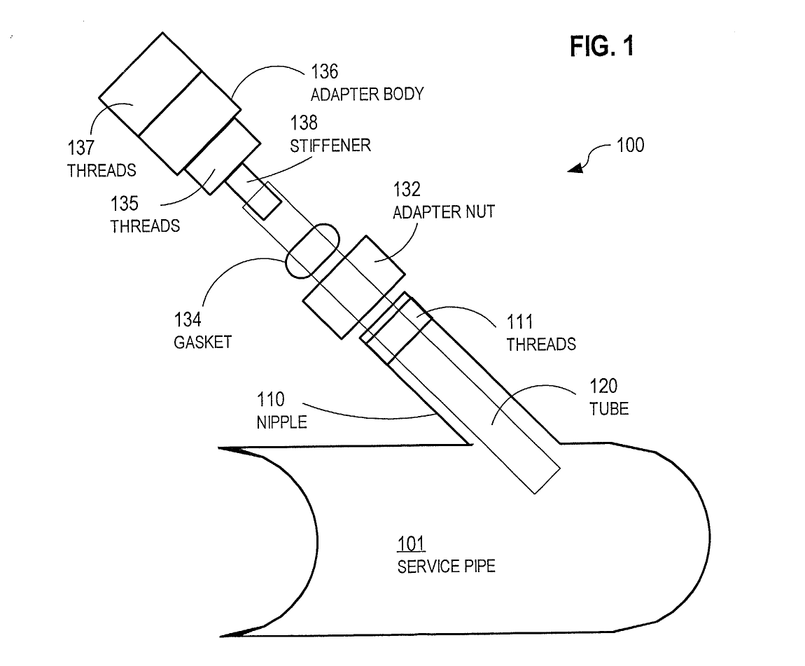

FIG. 1 is an exploded view of a pressure fitting 100 that seals the nipple to a plastic tube, according to one embodiment.

The nipple is a steel pipe 110 of inner diameter D1 welded to a steel service pipe 101 of inner diameter D2 substantially greater than D1. For example, service pipe 101 is a four inch steel pipe and pipe 110 is a 0.75 inch pipe. The steel pipe 110 is affixed to the service pipe at an angle of 45 degrees so that a flexible tube 120 inserted through the nipple 110 can be bent more easily to turn in one direction inside the service pipe 101 than in the opposite direction. The nipple 110 includes threads 111 for attaching other components.

A flexible tube 120 of outer diameter D3, less than D1, passes through the nipple 110 into the service pipe 101. For example, a 0.63-inch plastic tube passes through the nipple 110. Only a portion of the flexible tube 120 is depicted in FIG. 1; the tube may be arbitrarily long and extend along the inside of the service pipe 101 for a considerable distance, as described in more detail below.

After a flexible tube 120 is passed through the nipple 110, the remaining elements depicted in FIG. 1 form a pressure fitting that seals the tube 120 to the nipple 110. The illustrated pressure fitting includes an adapter nut 132 with female threads that engage threads 111 of the nipple 110. The fitting also includes a gasket 134 placed over the end of the tube 120 that juts out of the nipple 110 beyond the adapter nut 132. An adapter body 136 includes threads 135 that engaged the female threads of adapter nut 132. When engaged and tightened, the adapter body 136 presses on the gasket 134, deforming the gasket 134 to form a pressure-tight seal in the cavity between the nipple 110, the adapter nut 132, the adapter body 136 and the tube 120. In the illustrated embodiment, the adapter body 136 includes a hollow stiffener 138 to prevent the tube 120 from pinching closed when the adapter body is tightened. In one embodiment, the stiffener 138 rotates freely with respect to the rest of the adapter body 136. The adapter body includes threads 137 for attaching other components to the nipple assembly, such as a cap or a clamp that grabs a fiber optic cable later fed through the tube 120.

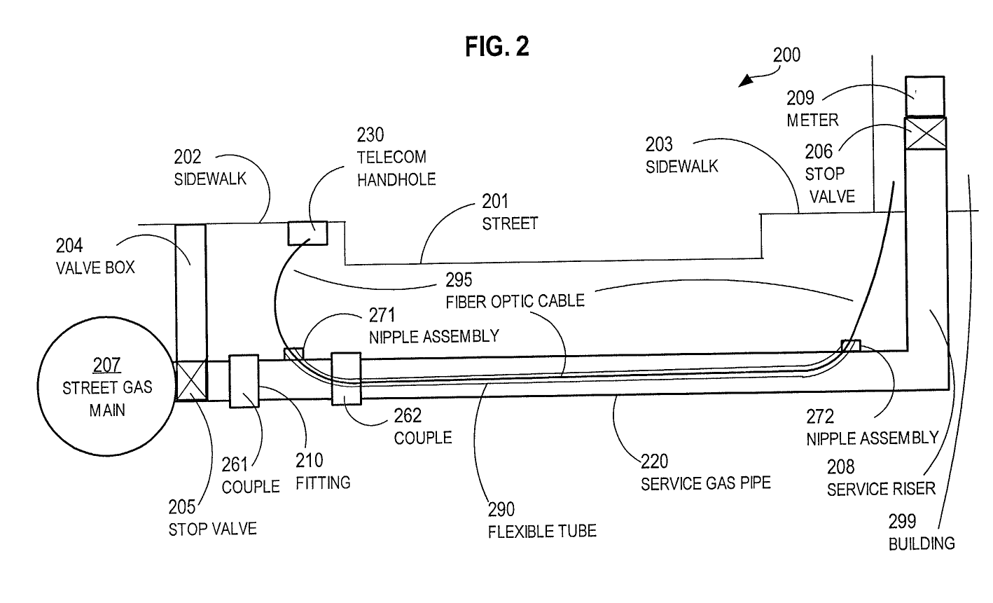

FIG. 2 is a cross section of a system 200 that uses an apparatus having a service pipe 220 with a fiber optic cable 295 in a sealed flexible tube 290, according to an embodiment. FIG. 2 depicts a street level 201 and sidewalk levels 202, 203 on either side of the street.

Before installing the system 200, the service pipe 220 is originally connected below street level 201 to a street gas main 207 through a stop valve 205. Stop valve 205 can be operated through a valve box 204 from the sidewalk level 202. Service pipe 220 is also connected to a building 299 through gas service riser 208, another stop valve 206, and a gas meter 209. For example, the service pipe 220 and the service riser 208 are 4-inch pipes; and the street gas main 207 is larger than 12 inches. A network cable that carries data for network services is available in telecom handhole 230 from the sidewalk level. In one embodiment, the network cable emerges from the street gas main 207 using an existing proprietary system. In another embodiment, the network cable in the handhole is laid there by some other existing means that does not use the street gas main 207.

After installing the system, the service pipe 220 includes two nipple assemblies 271 and 272 that form a pressure-tight seal with the flexible tube 290. A fiber optic cable 295 passes through the nipple assemblies 271, 271 and the flexible tube 290 inside the service pipe 220. One end of the fiber optic cable 295 connects to the network cable in telecom handhole 230. The other connects to equipment, not shown, in the building at the service riser 208.

According to the illustrated embodiment, one nipple assembly 271 is attached to the service pipe 220 on a fitting 210 joined to the service pipe 220 by couples 261 and 262. According to the illustrated embodiment, the system 200 is installed by cutting out a section of the service pipe 220 at a cross-street location convenient for connecting to the network cable. The cross-street location is indicated by the position of nipple assembly 271. The cut out section occupies that portion of the service pipe replaced by the fitting 210 depicted in FIG. 2. The cross-street location might be accessed by digging from sidewalk level 202, but does not need to involve cutting into the street, represented in FIG. 2 by the street level 201. In one embodiment, the nipple of nipple assembly 271 is attached to the section of pipe cut from the service pipe, so that the fitting 210 is fabricated from the cutout section of the service pipe.

The nipple of nipple assembly 272 is attached to the service pipe 220 at a building-side location convenient for connecting fiber optic cable to equipment in the building. The building-side location might be accessed by digging from sidewalk level 203, but does not need to involve cutting into the street.

According to one embodiment, the flexible tube is then passed through the nipple of nipple assembly 272, through the inside of the service pipe 220, and out an opening created by cutting out the section of the service pipe at the cross-street location. The opening is at about the position occupied in FIG. 2 by the couple 262. By tool or by hand, the flexible tube 290 is fed through the nipple of nipple assembly 271 on the fitting. In one embodiment, the fiber optic cable 295 is inside the tube 290 when the tube is fed through the nipples and service pipe. In another embodiment, the tube is empty. The fitting 210 is then joined to the service pipe with couples 261, 262.

Pressure fittings are then used to form a pressure-tight seal rated for a certain maximum pressures somewhat greater than the expected operating pressure for the gas delivery system. For example, the tube is passed through the adapter nut 132 and gasket 134 and fitted onto the stiffener 138 of adapter body 136; and the adapter nut is tightened. The seal is rated for pressures of about 75 psig to about 100 psig.

The fiber optic cable 295 is then pushed through the tube 290 until the cable 295 can be connected to the network cable in the telecom handhole 230. At the other end, the fiber optic cable 295 is connected to equipment in the building

Method of Pulling Cable

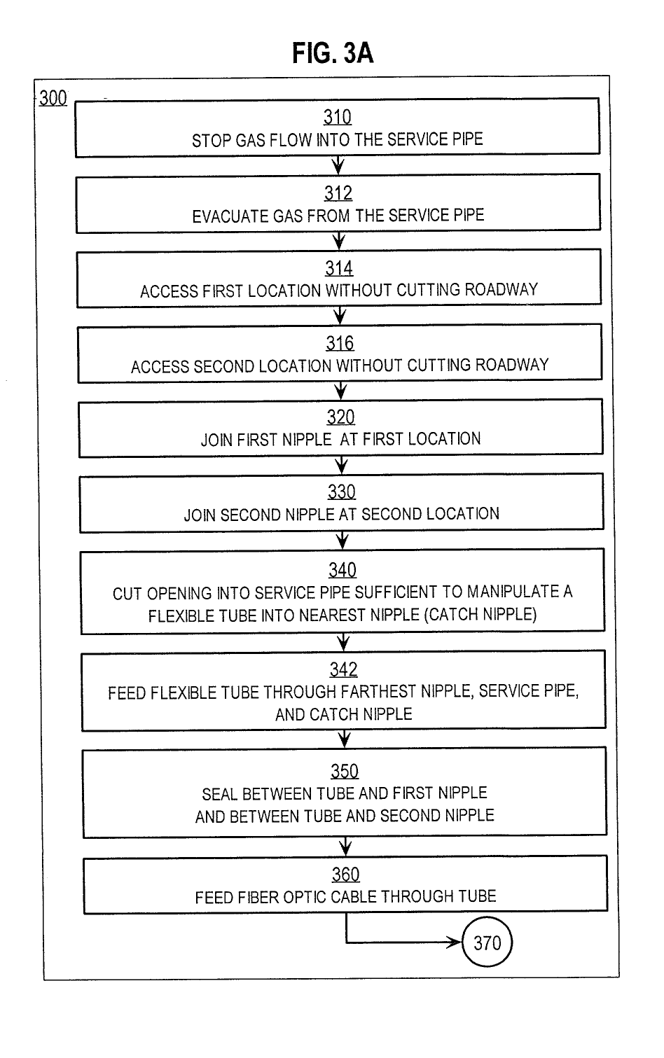

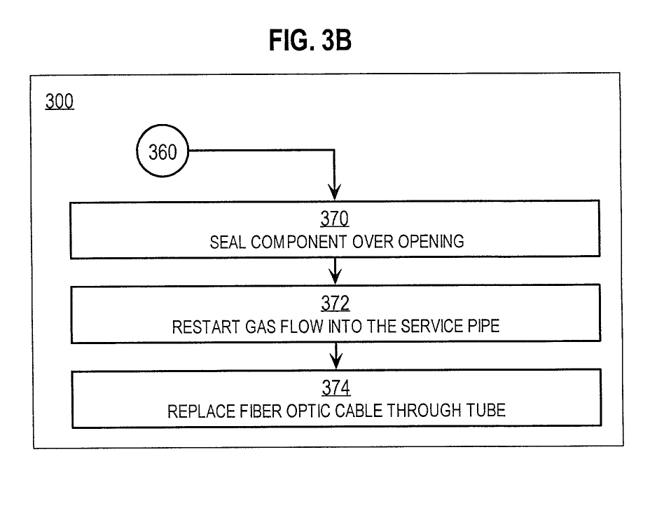

FIG. 3A and FIG. 3B together form a flowchart of a method 300 for pulling fiber optic cable through a service pipe, according to an embodiment. Although the steps are illustrated in the following flowcharts in a particular order, the steps may be reordered or occur at overlapping times in other embodiments.

Referring to FIG. 3A, in step 310, the flow of gas into the service pipe from the feeder gas main is stopped. For example, the stop valve 205 is closed by reaching through valve box 204 from sidewalk level 202 to stop the flow of gas from the street gas main 207 into the service pipe 220. In some embodiments, this step includes providing an alternative supply of gas to the building. For example, a tank of pressurized gas is provided and hooked up to the building's gas meter. In another embodiment, a by-pass pipe is connected from the gas meter to a different service pipe that is not fed through stop valve 205.

In step 312, the gas is purged from the service pipe. For example, a tap is cut into the service riser to let the gas escape to the atmosphere and exchange with ambient air. In some embodiments, a denser inert gas is forced through the tap to displace the original gas.

In step 314, the building-side location is accessed, digging an access hole to reach the location, if appropriate. For example, the service pipe 220 is uncovered just street-side of the service riser 208 with its valve 206 and gas meter 209. In a preferred embodiment, a roadway used by motor vehicles is not cut or disturbed during any digging. In step 316, the cross-street location is accessed, digging an access hole to reach the location, if appropriate. Again, in a preferred embodiment, a roadway used by motor vehicles is not cut or disturbed during any digging.

In step 320, a first nipple is joined to the service pipe 220 at the building-side location. For example, at that location a small diameter hole is drilled into the service pipe and a matching diameter pipe is welded at about a 45-degree angle to cover the hole in the service pipe. The nipple is angled such that the horizontal component of a vector, which has its base at the tip of the nipple and its head at the joint with the outer surface of the service pipe, is directed to the targeted location of the second nipple. Step 320 includes the step of forming a pressure tight seal between the nipple and the service pipe. In some embodiments, step 320 is performed after step 340 or after both steps 340 and 342, as described below.

In step 330, a second nipple is joined at the cross-street location. For example, at that location a small diameter hole is drilled into the service pipe and a matching diameter pipe is welded at about a 45-degree angle to cover the hole in the service pipe. The nipple is angled such that the horizontal component of a vector, which has its base at the tip of the nipple and its head at the joint with the outer surface of the service pipe, is directed to the targeted location of the first nipple. Step 330 includes the step of forming a pressure tight seal between the nipple and the service pipe. In some embodiments, step 330 is performed after step 340 or after both steps 340 and 342, as described below. In some embodiments, step 320 is performed after step 330 or overlapping in time with step 330.

In step 340 an opening is cut into the service pipe that is sufficiently large to allow an operator to manipulate a flexible tube through the nearest nipple (the catch nipple) from inside the service pipe. The manipulation may be performed manually or with the assistance of a tool. It is anticipated that some tools may allow the opening to be smaller than an opening used for manual handling of the tube. In embodiments in which the catch nipple is welded directly to the service pipe, the opening is cut nearby so that, during step 342 described below, an operator can reach in, grab the tube, and feed the tube up into the catch nipple from inside the service pipe. In other embodiments, described later, the opening is cut before the catch nipple is attached, the tube is fed through the catch nipple during step 342 described below, and the catch nipple is attached so as to close the opening.

In a preferred embodiment, step 340 comprises cutting and removing a longitudinal portion of the service pipe. For example, a portion of the service pipe is cut and removed at the cross-street location. The portion removed is located in FIG. 2 where the fitting 210 is depicted. Step 340 includes normal safety precautions for cutting into gas pipes. In some embodiments, step 340 includes installing, on the portion of the service pipe still connected to the street gas main, a temporary cap with a vent about three inches above the sidewalk level 202. In some embodiments, step 340 includes placing a Ventura assembly on the portion of the service pipe connected to the service riser to draw out remaining gas. In some embodiments, step 340 includes checking for trace amounts of gas to assure safe levels. For example, a JW leak detection unit is employed to ensure that gas concentrations are below one part per million by indicating a reading of 0% when the unit is set for a maximum scale of 4%.

In step 342, a flexible tube is fed through the farthest nipple from the opening, in the direction from outside to inside the service pipe, through the service pipe, and then through the catch nipple. The tube is fed through the catch nipple using the opening cut in step 340.

In some embodiments either step 320 or step 330 or both overlap or follow step 340 of cutting an opening in the service pipe. In some such embodiments, joining the catch nipple overlaps or follows step 342 for feeding a flexible tube through the catch nipple.

In one of these embodiments, in which at least one of steps 320, 330 overlaps steps 340, 342, joining the catch nipple includes attaching the catch nipple to a sleeve and then welding the sleeve to the service pipe over the opening. This step overlaps the step of feeding the tube through the nipple after the nipple is attached to the sleeve and before the sleeve is welded to the service pipe. In other of these embodiments, joining the catch nipple includes attaching the catch nipple to the longitudinal portion of the service pipe removed to create the opening in step 340 and then joining the longitudinal portion with the catch nipple attached back onto the service pipe with a pair of couples. This step overlaps the step of feeding the tube through the nipple after the nipple is attached to the longitudinal portion and before the longitudinal portion is joined to the service pipe.

For example, the tube is fed through the nipple of nipple assembly 272 at the building-side location, along the inside of service pipe 220 to the opening of the longitudinal portion, which occurs in FIG. 2 at the position of the couple 262. In this example, an operator's hand reaches through the opening cut in step 340, grabs the tube and feeds the tube through the longitudinal portion cut from the service pipe and through the catch nipple of nipple assembly 271, from inside the longitudinal portion to the outside. The longitudinal portion is then attached to the service pipe portions still in place. For example, the longitudinal portion is welded to the portions still in place, or joined with a pair of couples 261, 262.

A result of this embodiment is depicted in FIG. 2, in which the fitting 210 comprises the longitudinal portion of the service pipe with the catch nipple attached, and the couples 261 and 262 join the longitudinal portion to the in-place portions of the service pipe 220. In some other embodiments, the longitudinal portion is cut at the building-side location and the first nipple is the catch nipple.

In step 350, the flexible tube is sealed against the first and second nipples. The seals prevent the leakage of gas from the service pipe up to a maximum pressure that exceeds the expected operating pressure. In the preferred embodiment, the maximum pressure is selected in the range from about 75 psig to about 100 psig for an operating pressure of 60 psig. The flexible tube is therefore chosen to be impermeable to the gas in the service pipe at least up to the maximum pressure. In some embodiments, step 350 is performed before the fitting 210 with the catch nipple is joined to the service pipe 220.

For example, referring to FIG. 1, step 350 includes attaching an adapter nut 132 to threads 111 on each of the nipples. Then a gasket 134 is placed around the tube at each end jutting from the two nipples. Then the stiffener 138 of an adapter body 136 is inserted into the tube at each end, and the threads 135 of the adapter body 136 are engaged with the female threads of adapter nut 132 on each nipple. The adapter body 136 is rotated to tighten it against the gasket 134 and adapter nut 132 until a seal sufficiently tight to withstand 100 psig is formed. For example, nipple assemblies 271 and 272 in FIG. 2 are formed as a result of step 350.

In some embodiments, step 350 includes multiple steps conventionally performed for testing pressure seals. For example, for an operating pressure of 60 psig, the maximum pressure may be set at 100 psig. In one embodiment, a 100 psig test is performed on the flexible tube for ten minutes, checking for leaks with soap applied to the nipple assemblies. This embodiment also includes installing a test cap over the opening at the cross-street location, injecting inert gas or air to a pressure of 100 psig and testing for leaks at all fittings for ten minutes, then purging the test gas from the service pipe.

In step 360 a fiber optic cable is fed through the flexible tube. The cable is fed in either direction, either from the building-side location to the cross-street location, or in the opposite direction. In some embodiments, the fiber optic cable is inside the flexible tube when the flexible tube is fed during step 342. Step 360 includes pulling the fiber optic cable through the tube so that a length sufficient to reach a network cable juts out of the second nipple, the nipple at the street-side location.

Referring to FIG. 3B, in step 370 a pressure tight seal is formed over the opening. Step 370 is optional in embodiments in which the step of joining the catch nipple, either step 320 or step 330, also serves to cover and seal the opening cut in step 340. Step 370 is employed in embodiments in which the catch nipple is welded directly to the service pipe near the opening cut in step 340. After feeding the flexible tube through the catch nipple, the opening is sealed in step 370.

In step 372, the flow of gas into the service pipe is restarted. For example, in the illustrated embodiment stop valve 205 is opened. This embodiment also includes pressurizing the service pipe and checking all fittings for leaks with soap film, including the couples 361, 362 and the nipple assemblies, 371, 372. After passing the test, this embodiment includes bonding the couples, priming and wrapping all connections. Some embodiments include reconnecting the service riser 208 if it was disconnected, removing a by-pass line or tank connected to provide temporary service, and checking gas equipment in the building to ensure all are operating properly and that the gas pressure is set in the correct range. In some embodiments, step 372 includes refilling any access holes dug, and otherwise cleaning up the work sites.

In step 374, a fiber optic cable in the flexible tube is replaced. Gas service to the building through the service pipe is not interrupted. For example, stop valve 205 is not turned off. Instead, the old cable 295 is extracted through one of the nipples and the new cable is fed through one of the nipples. In some embodiments, the replacement cable is attached to the old cable 295 so that extracting the old cable 295 simultaneously pulls the new cable through the tube 290.

Method of Supplying Network Service

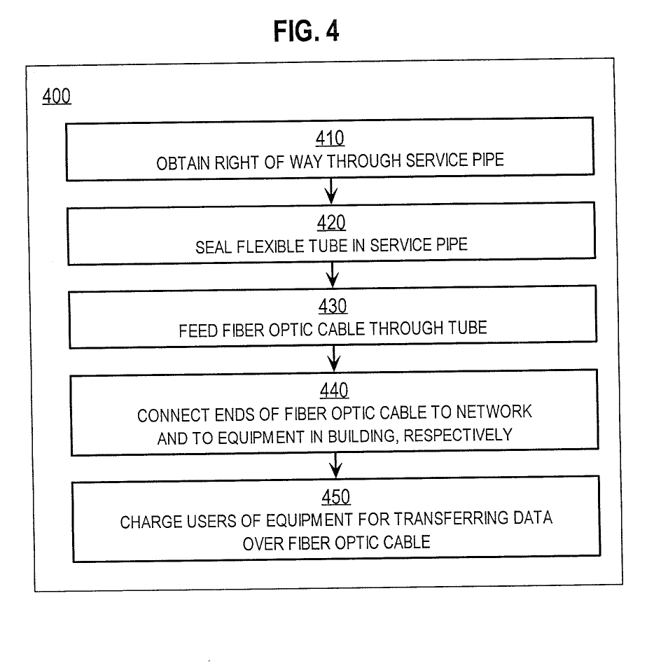

FIG. 4 is a flow chart of a method 400 for supplying network services over a fiber optic cable to a particular building, according to an embodiment.

In step 410 a right of way is obtained to use a service pipe for passing fiber optic cable between a network cable and the building. Typically, the service pipe is on private property and is owned by the owners of the building. In some cases, however, the permission of the gas utility will also have to be obtained. A lease of property rights might be involved.

In step 420 a flexible tube in sealed in the service pipe. The tube is sealed in such a manner as to not leak for pressures up to a certain maximum pressure. For example, tube 290 is sealed in service pipe 220 with pressure fittings at nipple assemblies 271 and 272 so as not to leak gas at least up to a pressure of 100 psig, as described above for steps 310 through 350 of method 300.

In step 430 a fiber optic cable is fed through the flexible tube. For example fiber optic cable 295 is installed with the flexible tube, as described above for step 360. In other embodiments, the fiber optic cable 295 is pushed through the flexible tube 290 after the flexible tube is sealed into the service pipe 220, as also described above. Step 430 also includes replacing the original fiber optic cable 295 by feeding a new fiber optic cable through the tube 290, as described above for step 374.

In step 440, the two ends of the fiber optic cable are connected to the network cable and to equipment in the building, respectively. For example, one end of fiber optic cable 295 closest to nipple assembly 272 is connected to a hub in building 299. The other end of fiber optic cable 295 is connected to a network cable that is connected to the network, in the telecom handhole 230.

In step 450, users of the equipment in the building are charged for transferring data over the network using any method known in the art when the network services are provided.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus for supplying network services over fiber optic cable to a particular building, the apparatus comprising:
a service pipe that conveys gas between a gas main and a gas meter for the particular building;
a flexible tube disposed inside the service pipe, the tube sealed at each end to an outside surface of the service pipe at a pressure fitting for providing access to an inside of the tube; and
a fiber optic cable disposed inside the flexible tube, with each end of the fiber optic cable outside the service pipe.

2. The apparatus of claim 1, wherein the flexible tube does not leak at an operating gauge pressure for gas between the tube and an inside of the service pipe.

3. The apparatus of claim 1, wherein the pressure fitting does not leak at an operating gauge pressure for gas between the tube and an inside of the service pipe.

4. The apparatus of claim 1, wherein:
a first pressure fitting, at one end of the flexible tube, is at a first location convenient for connecting the fiber optic cable to the particular building; and
a second pressure fitting, at a different end of the flexible tube, is at a second location convenient for connecting the fiber optic cable to a network cable.

5. The apparatus of claim 1, wherein a diameter of the service pipe is less than about six inches.

6. A method for pulling fiber optic cables through gas service pipes, the method comprising the steps of:
stopping gas flow from a gas main to a service pipe that conveys gas between the gas main and a gas meter for a particular building;
joining to the service pipe, at a first location convenient for connecting fiber optic cable to the particular building, a first nipple that provides for a flexible tube a pass way between an inside of the service pipe and an outside of the service pipe;
joining to the service pipe, at a second location convenient for connecting fiber optic cable to a network cable, a second nipple that provides for the flexible tube a pass way between the inside of the service pipe and the outside of the service pipe;
feeding the flexible tube through a catch nipple of the first nipple and the second nipple after passing the flexible tube through a different nipple of the first nipple and the second nipple and through the inside of the service pipe;
sealing the flexible tube to the first nipple and the second nipple for pressures up to a predetermined maximum pressure; and
feeding a fiber optic cable through the flexible tube.

7. The method of claim 6, wherein a diameter of the service pipe is less than about six inches.

8. The method of claim 6, wherein a diameter of the service pipe is greater than about one inch.

9. The method of claim 6, further comprising the step of cutting an opening into the service pipe, the opening sufficient for reaching the flexible tube inside the service pipe and manipulating the flexible tube into the catch nipple.

10. The method of claim 6, further comprising the step of evacuating gas from the service pipe after said step of stopping the gas flow and before said steps of joining the first nipple and joining the second nipple.

11. The method of claim 6, further comprising the step of restoring gas flow into the service pipe after said steps of sealing the flexible tube, joining the first nipple, and joining the second nipple.

12. The method of claim 9, further comprising, before said step of restoring the gas flow, performing the step of sealing to the service pipe a component that covers the opening for pressures up to the predetermined maximum pressure.

13. The method of claim 12, wherein the component that covers the opening includes the catch nipple.

14. The method of claim 12, wherein the component that covers the opening includes a fitting and two couples.

15. The method of claim 6, wherein the predetermined maximum pressure is in a range from about 75 pounds per square inch, in gauge pressure, (psig) to about 100 psig.

16. The method of claim 11, wherein said step of feeding the fiber optic cable through the flexible tube is performed after said step of restoring the gas flow.

17. The method of claim 11, further comprising replacing the fiber optic cable passing through the flexible tube after said step of restoring the gas flow.

18. The method of claim 9, said step of cutting the opening further comprising removing a longitudinal portion of the service pipe.

19. The method of claim 9, wherein:
the first nipple is the catch nipple;
said step of joining the first nipple is performed after said steps of cutting the opening and feeding the flexible tube through the catch nipple; and
said step of joining the first nipple further comprises
covering the opening with a component including the catch nipple, and
sealing the component to the service pipe for pressures up to the predetermined maximum pressure.

20. The method of claim 9, wherein:
the second nipple is the catch nipple;
said step of joining the second nipple is performed after said steps of cutting the opening and feeding the flexible tube through the catch nipple; and
said step of attaching the second nipple further comprises
covering the opening with a component including the catch nipple, and
sealing the component to the service pipe for pressures up to the predetermined maximum pressure.

21. The method of claim 6, said step of joining the first nipple further comprising sealing the first nipple to the service pipe for pressures at least up to the predetermined maximum pressure.

22. The method of claim 6, said step of joining the second nipple further comprising sealing the second nipple to the service pipe for pressures at least up to the predetermined maximum pressure.

23. The method of claim 6, further comprising accessing the first location without cutting into a roadway that is used for the passage of motor vehicles.

24. The method of claim 6, further comprising accessing the second location without cutting into a roadway that is used for the passage of motor vehicles.

25. A method for supplying network services over fiber optic cables to a particular building, the method comprising the steps of:
sealing, for pressures up to a predetermined maximum pressure, a flexible tube in a service pipe from a first point proximate to the particular building to a second point proximate to a network cable, wherein the service pipe conveys gas between a gas main and a gas meter for the particular building;
feeding a fiber optic cable through the flexible tube;
connecting a first end of the fiber optic cable adjacent to the first point to equipment in the particular building; and
connecting a second end of the fiber optic cable adjacent to the second point to the network cable.

26. The method of claim 25, further comprising the step of obtaining rights for sealing the flexible tube in the service pipe from a party having property rights over the service pipe.

27. The method of claim 25, further comprising the step of charging users of the equipment in the particular building for transferring data over the fiber optic cable.
